(19) United States
(12) Patent Application Publication
(10) Pub. No.: US 2010/0108179 A1
(43) Pub. Date: May 6, 2010

(54) VEHICLE-BASED MOBILE FLUID DELIVERY SYSTEM APPARATUS AND METHODS

(75) Inventor: Donald L. Emerson, JR., Oregon City, OR (US)

Correspondence Address: Silicon Forest Patent Group;Paul J. Fordenbacher, 11876 NW Tyler Ct, Portland, OR, 97229, US

(73) Assignee: FLEET MAINTENANCE, INC., Portland, OR (US)

(21) Appl. No.: 12/531,065

(22) PCT Filed: Mar. 13, 2008
(86) PCT No.: PCT/US2008/056922

§ 371 Date: Sep. 12, 2009

Related U.S. Application Data
(60) Provisional application No. 60/894,605, filed on Mar. 13, 2007.

(51) Int. Cl. B65B 3/04; B67D 7/06

(52) U.S. Cl. 141/1; 222/129

(57) ABSTRACT

The subject matter disclosed herein relates to vehicle-based mobile fluid delivery apparatus and methods for dispensing fluid from a vehicle-based tank.

### RELATED APPLICATION

This is a PCT application claiming priority to U.S. Provisional application No. 60/894,605, filed on Mar. 13, 2007, which is in its entirety incorporated herewith by reference.

### FIELD OF THE INVENTION

The present invention is related to vehicle-based mobile fluid delivery systems, and more particularly, to apparatus and methods for dispensing fluid from a vehicle-based tank.

### BACKGROUND

Vehicle-based mobile fluid delivery systems are used in a number of applications, such as, but not limited to, the dispensing of fluid-based lawn chemicals. Vehicles used for the delivery and dispensing of fluid-based lawn chemicals commonly have a fluid storage tank that dispenses the fluid contents through a hose via a pump. The pump creates the fluid pressure required to dispense the fluid and to create the desired spray pattern and range from the nozzle coupled to the dispensing end of the hose, such that the service personnel can spray the fluid on a lawn, for example.

A common size of the fluid storage tank adapted for lawn service is 400 gallons. The pump drives the fluid in the storage tank through a hose. A common quantity of fluid dispensed at each service call is approximately 5 to 10 gallons for a small residential lawn.

The pump is commonly powered via a power take-off (PTO) driven by the engine of the vehicle, commonly off of a drive gear in the transmission; the output shaft of the PTO engaging the pump via a clutch pack. In standard operation, the pump is engaged with the PTO and the engine is driven at a high idle speed sufficient to drive the pump. The pump is left engaged with the PTO, and thus the engine is operated at high idle, for the duration of the service call, so as to maintain the fluid pressure in the hose.

Continuous operation of the vehicle engine at high idle is associated with loud engine noise, air pollution, high consumption of fuel, increased wear on the vehicle engine/transmission, pump, and the PTO, among other things. Continuous operation of the pump, and therefore operating the vehicle engine at high idle, is mainly due to convenience of operation. It is not uncommon for the hose to be extended hundreds of feet, for example 400 feet or more, from where the pump controls are located. Further, it is not uncommon for the operator to wear protective gear, including bulky water-proof gloves and body coverings, making the operation of control switches difficult and inconvenient. Therefore, it is common practice for the operator to leave the pump engaged with the PTO with the vehicle engine running at high idle throughout the service call which can be for ten's of minutes.

The pump commonly used is a diaphragm pump. A diaphragm pump is a positive displacement pump that uses a combination of the reciprocating action of a flexible diaphragm and check valves. The diaphragm is flexed causing the volume of the pump chamber to increase, decreasing the pressure and drawing the fluid into the chamber. When the diaphragm is flexed causing the volume of the pump chamber to decrease, the chamber pressure increases forcing the fluid currently drawn in out.

A significant problem with current fluid delivery vehicles relates to problems associated with the conveyed fluid. The chemical composition of the fluid-based lawn chemicals, for example, can be highly corrosive, such as associated with iron-based moss killer and fertilizer. Positive displacement pumps are particularly susceptible to damage caused by the corrosive fluid dispensed and left therein. Such corrosion damage to a pump can cause downtime for the fluid vehicle and necessitate the repair or replacement of the damaged pump at considerable expense, particularly since these types of pumps can be relatively expensive and/or time consuming to repair or replace. Moreover, if delays are encountered in obtaining a replacement pump or parts therefore, the downtime for the fluid vehicle can substantially increase substantially impairing economic value.

Current fluid-delivery vehicles with pumps driven by PTO's thus tend to be relatively complex and require time-consuming purging and cleaning procedures.

A PTO drive system can add considerably to both the initial cost and the ongoing maintenance expenses associated with a fluid-delivery vehicle. Such current vehicles and their fluid distribution systems also tend to have a number of moving parts, which are susceptible to damage and wear from corrosion.

It is therefore desired to provide a fluid delivery system wherein the fluid is delivered as needed with relatively few moving parts and with less corrosion concerns. Moreover, it is desired to provide a fluid delivery system which is not dependent on the engine idle speed yet provides reliable pressurization for attaining operating pressures of up to 300 PSI or more, and to provide such a system which can accommodate various fluid-delivery application procedures.

What is needed in the art is a vehicle-based mobile fluid delivery system with a pressurized discharge system that overcomes the limitation of current systems and that provides dispensing of the fluid product without the associated high idle operation of the vehicle and without the associated maintenance issues of the pump.

### BRIEF DESCRIPTION OF THE DRAWINGS

Like reference numbers generally indicate corresponding elements in the figures.

FIG. 1 illustrates a vehicle-based mobile fluid delivery system in accordance with an embodiment; and

FIG. 2 is a schematic of a fluid-delivery system in accordance with an embodiment.

### DETAILED DESCRIPTION

Reference will now be made to embodiments illustrated in the drawings and specific language which will be used to describe the same. It will nevertheless be understood that no limitation of the scope of the invention is thereby intended, such alterations and further modifications in the illustrated devices, as such further applications of the principles of the invention as illustrated therein as being contemplated as would normally occur to one skilled in the art to which the invention relates.

Embodiments in accordance with the present invention provide a vehicle-based mobile fluid-delivery system. The fluid-delivery is provided by apparatus comprising a secondary storage tank pressurized by gas pressure. The gas pressure is provided by any suitable means, including means associated with a compressor, compressed gas cylinder, and the like.

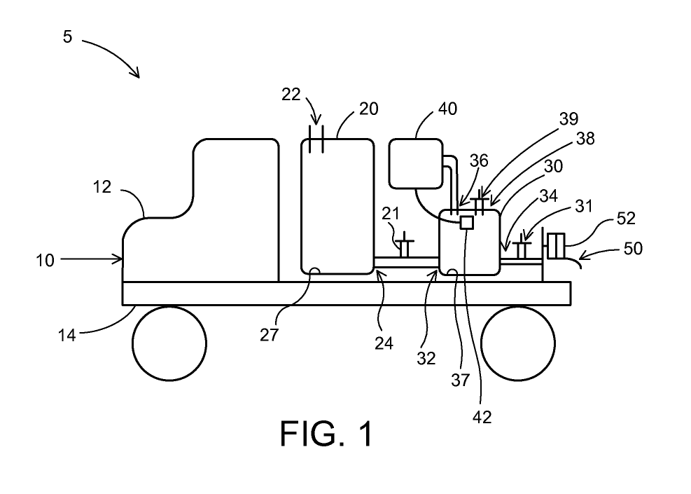

FIG. 1 illustrates a vehicle-based mobile fluid delivery system 2 comprising a primary storage tank 20, a secondary storage tank 30, a gas pressure supply 40 adapted to pressurize the secondary storage tank 30, and a discharge outlet 50, in accordance with an embodiment of the present invention. The vehicle-based mobile fluid delivery system 2 may be adapted to be coupled to a vehicle 10. The vehicle 10 may include a cab 12 and a chassis 14, the chassis 14 being adapted for mounting the fluid handling components.

The primary storage tank 20 is a fluid containment vessel including a primary inlet 22 adapted for filling the primary storage tank 20 with a fluid, and a primary outlet 24 adapted for dispensing fluid therefrom. The primary storage tank 20 may be fabricated from any material adapted for containment of a desired fluid, such as, but not limited to, metal, polymer and fiberglass material. The primary storage tank 20 has a predetermined fluid capacity, such as, but not limited, to that associated with a day's worth of fluid delivery.

The secondary storage tank 30 is a containment vessel having a secondary inlet 32, a secondary outlet 34, a pressure inlet 36, and a pressure outlet 38. The secondary inlet 32 is adapted for coupling in fluid engagement with the primary outlet 24 of the primary storage tank 20. The secondary outlet 34 is adapted for dispensing the fluid from the secondary storage tank 30. Control of fluid from the primary storage tank 20 to the secondary storage tank 30 may be provided by a first valve 21 in fluid engagement with the primary outlet 24 and secondary inlet 32. Control of fluid from the secondary storage tank 30 to the secondary outlet 34 may be provided by a second valve 31 in fluid engagement with the secondary outlet 34. The pressure inlet 36 is coupled in fluid engagement with the pressure supply 40. The pressure supply 40 is adapted for providing gas pressure to the secondary storage tank 30. The pressure outlet 38 may be provided with a pressure release valve 39 in fluid engagement therewith for overpressure protection and pressure relief. The secondary storage tank 30 may be fabricated from any material adapted for containment of a desired fluid under pressure, such as, but not limited to, metal, polymer and fiberglass material.

The secondary storage tank 30 may have any fluid capacity. The secondary storage tank 30 may have a predetermined fluid capacity such as, but not limited to, that associated with a single application of fluid delivery at a job site. In accordance with an embodiment of the present invention, the secondary storage tank 30 may have a capacity of 5 to 10 gallons so as to provide fluid for a single application. In accordance with another embodiment of the present invention, the secondary storage tank 30 may have a capacity of 30 to 50 gallons so as to provide fluid for a large single application or provide for multiple applications without the need to release the gas pressure and fill and pressurize the secondary storage tank 30 as often as compared with a smaller capacity.

Gas pressure may be provided to the pressure inlet 36 of the secondary storage tank 30 with apparatus associated with a gas pressure supply 40. Apparatus associated with gas pressure supply 40 includes, but is not limited to, a compressor and compressed gas cylinders. Air compressors include, but not limited to, electric, gas and hydraulic-driven compressors. A compressor may be driven off of an electric, gas and/or hydraulic system of the vehicle 10, or an independent system such as, but not limited to, storage batteries. In accordance with an embodiment of the present invention, the gas pressure supply 40 may be an air compressor driven by an electrical system of the vehicle 10, such as, but not limited to a 12 or 24 volt electrical system. In accordance with another embodiment of the present invention, the gas pressure supply 40 may be an electric air compressor powered by storage batteries that are charged by an electrical system of the vehicle 10. In accordance with another embodiment of the present invention, the gas pressure supply 40 may be an electric air compressor powered by storage batteries.

In an embodiment in accordance with the present invention, the pressure supply 40 further comprises a pressure switch 42 adapted for sensing pressure in the secondary storage tank 30. When the pressure switch 42 detects that the pressure is below a predetermined value, the pressure supply 40 is caused to engage and increase the pressure in the secondary storage tank 30. When the pressure switch 42 detects that the pressure is above a predetermined value, the pressure supply 40 is disengaged.

In accordance with an embodiment wherein the pressure supply 40 is an air compressor, engagement and disengagement with the secondary storage tank 30 is affected by use of a controller turning the compressor on/off. In accordance with an embodiment wherein the pressure supply 40 is a compressed gas cylinder, engagement and disengagement with the secondary storage tank 30 is affected by use of a valve opening/closing gas communication between the secondary storage tank 30 and the cylinder.

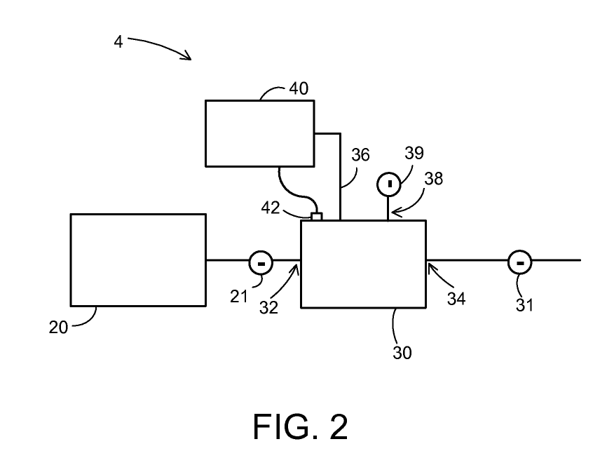

FIG. 2 is a schematic of a fluid-delivery system 4 in accordance with an embodiment of the present invention. The fluid-delivery system 4 comprises a secondary storage tank 30 and a pressure supply 40 in fluid engagement therewith adapted to pressurize the secondary storage tank 30. The secondary storage tank 30 comprises a secondary inlet 32 with fluid communication controlled by a first valve 21, a secondary outlet 34 with fluid communication controlled by a second valve 31, a pressure inlet 36 adapted to couple in fluid engagement with the pressure supply 40, and a pressure outlet 38 with fluid communication controlled by a pressure valve 39.

Referring again to FIGS. 1 and 2, in accordance with an embodiment of a process of the present invention, the pressure valve 39 is opened to bring the secondary storage tank 30 to atmospheric pressure. The first valve 21 is opened and fluid from the primary storage tank 20 is supplied to the secondary storage tank 30 by, such as, but not limited to, gravity feed. The secondary storage tank 30 is filled with a predetermined quantity of fluid. The first valve 21 is closed and the pressure valve 39 is closed and set in an overpressure protection operation. The pressure supply 40 is caused to engage and pressurize the secondary storage tank 30 to a predetermined pressure above atmosphere, such as, but not limited to 125 psi. The second valve 31 is opened so as to dispense the fluid, such as, but not limited to, through a hose 52 coupled to and in fluid communication with an outlet of the second valve 31, the gas pressure maintained to a predetermined pressure within the secondary storage tank 30 so as to dispense the fluid.

In accordance with an embodiment of the present invention, the fluid-delivery system 4 further comprises a pressure switch 42. The pressure switch 42 is located so as to sense the pressure within the secondary storage tank 30. The pressure switch 42 is in sensing communication with the pressure supply 40. The engagement and disengagement of the pressure supply 40 may be controlled by a signal from the pressure switch 42. In an automatic operation in accordance with an embodiment, the pressure switch 42 controls the operation of the pressure supply 40 by engaging and disengaging the pressure supply 40 in accordance with the pressure switch 42 sensing a predetermined pressure range, such as, but not limited to, 125-150 psi, and thus, controlling the pressure within the secondary storage tank 30 within the predetermined pressure range. The operation of the pressure supply 40 is thus controlled so as to provide a pressure within the secondary storage tank 30 within a predetermined range without intervention by the operator. The pressure supply 40 is controlled on an as-needed basis rather than on a continual basis.

Referring again to FIG. 1, in accordance with an embodiment, the primary outlet 24 may be adjacent to and/or a part of a primary storage tank bottom 27 of the primary storage tank 20, and likewise, secondary inlet 32, may be adjacent to and/or a part of a secondary storage tank bottom 37 of the secondary storage tank 30. The relative position of the primary outlet 24 being adjacent the primary storage tank bottom 27 and the secondary inlet 32 being adjacent the secondary storage tank bottom 37 facilitates the process of fluid transport and mixing described below.

Referring to FIGS. 1 and 2, in accordance with an embodiment of a process for filling the secondary storage tank 30 with fluid from the primary storage tank 20, the pressure valve 39 is opened to bring the secondary storage tank 30 to atmospheric pressure. The first valve 21 is opened and fluid from the primary storage tank 20 is supplied to the secondary storage tank 30. The secondary storage tank 30 is filled with a predetermined quantity of fluid. The movement of fluid from the primary outlet 24 to the secondary inlet 32 and into the secondary storage tank 30 creates fluid turbulence at the secondary storage tank bottom 37 which is particularly helpful in stirring up and mixing any sedimentary products in the fluid. For example, certain lawn care products, such as those containing ferrous sulfate for killing moss in lawns, will settle out within the secondary storage tank 30 without suitable agitation. The movement of fluid from the secondary inlet 32 into the secondary storage tank 30 helps to suspend or mix product that might otherwise settle.

In accordance with an embodiment of a process for dispensing fluid from the secondary storage tank 30 through a hose 52, the first valve 21 is closed and the pressure valve 39 is closed and set as an overpressure protection operation. The pressure supply 40 is caused to engage and pressurize the secondary storage tank 30 to a predetermined pressure above atmosphere. The second valve 31 is opened so as to dispense the fluid, such as, but not limited to, through the hose 52 coupled to the outlet of the second valve 31, the gas pressure maintained to a predetermined pressure within the secondary storage tank 30 so as to dispense the fluid under pressure.

In accordance with an embodiment of a process for back-flushing fluid from the secondary storage tank 30 back into the primary storage tank 20, the second valve 31 is closed and the pressure within the secondary storage tank 30 is raised to a higher pressure head than that at the primary outlet 24. The primary storage tank 20 may remain open to the atmosphere so as to maintain atmospheric pressure within the primary storage tank 20. The first valve 21 is opened and fluid from the secondary storage tank 30 is supplied to the primary storage tank 20 as the pressure in the secondary storage tank 30 reduces to that of the primary storage tank 20.

In accordance with another embodiment of a process for back-flushing fluid from the secondary storage tank 30 back into the primary storage tank 20, the second valve 31 is closed and the pressure within the secondary storage tank 30 is raised to a higher pressure head than that at the primary outlet 24. The primary storage tank 20 may remain open to the atmosphere so as to maintain atmospheric pressure within the primary storage tank 20. The first valve 21 is opened and fluid from the secondary storage tank 30 is supplied to the primary storage tank 20 as the pressure in the secondary storage tank 30 is controlled to maintain a higher pressure that that at the primary outlet 24 such that substantially all of the fluid is removed from the secondary storage tank 30. The secondary storage tank 30 may be substantially emptied into the primary storage tank 20 where the secondary inlet 32 is in close proximity to the secondary storage tank bottom 37.

The movement of fluid from the secondary storage tank 30 to the primary storage tank 20 remixes the fluid and creates fluid turbulence in the primary storage tank bottom 27 which is particularly helpful in stirring up and mixing any sedimentary products in the fluid.

In accordance with an embodiment of a process, the secondary storage tank 30 may be substantially emptied into the primary storage tank 20 after a service call and the secondary storage tank 30 refilled with fluid from the primary storage tank 20 before the next service call. In this way, the fluid dispensed from discharge outlet 50 is relatively well mixed from the fluid mixing during the back-flushing and filling process of the secondary storage tank 30.

It is appreciated that complete emptying of the secondary storage tank 30 is not necessary to create fluid mixing. Fluid mixing will occur with the addition of fluid from the primary storage tank 20 into the secondary storage tank 30.

Embodiments in accordance with the present invention provide a vehicle-based mobile fluid delivery system that addresses the limitations of current systems. The power take-off (PTO) subsystem may be eliminated such that the operation of the pressurization system is not dependent on the operation of the vehicle engine. Therefore the engine of the vehicle need not be running for the operation of the fluid delivery system, thus saving in fuel costs, reducing noise and air pollution, and reducing engine wear and tear. The fluid pump has been eliminated in favor of a gas pressure delivery system eliminating the cleaning, maintenance and replacement issues associated with current fluid delivery systems. With the elimination of the pump and associated PTO elements, the components and complexity of the system is greatly reduced resulting in reduced equipment costs. Since a pump is not used in the fluid stream, fluids not adapted for pumping, or particularly damaging or corrosive to a pump, can be used with this system.

It is understood that the embodiments described are adapted for fluid delivery systems of many types, such as, but not limited to, the dispensing of lawn care chemicals, the dispensing of seed/mulch slurries used for reseeding bare ground, and spray-down/cleaning of equipment, among many others.

While the invention has been described in connection with specific embodiments thereof, it will be understood that it is capable of further modification, and this application is intended to cover any variations, uses, or adaptations of the invention following, in general, the principles of the invention and including such departures from the present disclosure as come within known or customary practice in the art to which the invention pertains and as may be applied to the essential features hereinbefore set forth, and as fall within the scope of the invention and the limits of the appended claims.

1. A vehicle-based mobile fluid delivery system comprising:
a primary storage tank including a primary inlet and a primary outlet;
a secondary storage tank including a secondary inlet, a secondary outlet, a pressure inlet, and a pressure outlet;
a first valve in fluid engagement with the secondary inlet and the primary outlet;
a gas pressure supply in fluid engagement with the pressure inlet and in operative engagement therewith to pressurize the secondary storage tank; and
a second valve in fluid engagement with the secondary outlet.

2. The system of claim 1, further comprising a pressure switch in operative engagement to sense pressure within the secondary storage tank, the pressure switch in communication with the pressure supply and operable to control the operation of the pressure supply by engaging and disengaging the pressure supply in accordance with the pressure switch sensing a predetermined pressure.

3. The system of claim 2, the primary storage tank further comprising a primary tank bottom, the primary outlet being adjacent to the primary storage tank bottom, the secondary storage tank further comprising a secondary storage tank bottom, the secondary inlet being adjacent to the secondary storage tank bottom.

4. The system of claim 3, the primary storage tank further comprising a primary inlet operable for filling the primary storage tank with a fluid, and a primary outlet operable for dispensing fluid from the primary storage tank.

5. The system of claim 4, the secondary inlet operable for coupling in fluid engagement with the primary outlet of the primary storage tank, the secondary outlet operable for dispensing the fluid from the secondary storage tank, wherein control of fluid from the primary storage tank to the secondary storage tank is provided by the first valve in fluid engagement with the primary outlet and secondary inlet, and control of fluid from the secondary storage tank to the secondary outlet adapted operable to be controlled by a second valve in fluid engagement with the secondary outlet, the pressure inlet being coupled in fluid engagement with the pressure supply, the pressure supply operable for providing gas pressure to the secondary storage tank, a pressure release valve in fluid engagement with the pressure outlet operable for pressure release.

6. The system of claim 5, further comprising a storage battery, the gas pressure supply comprising an electric compressor in electrical communication with the storage battery.

7. The system of claim 5, the gas pressure supply comprising a compressed gas cylinder.

8. The system of claim 5, the gas pressure supply comprising an electric compressor in electrical communication with an electrical system of a vehicle.

9. A method for filling a secondary storage tank with fluid from a primary storage tank comprising:
providing a vehicle-based mobile fluid delivery system comprising:
a primary storage tank including a primary inlet and a primary outlet;
a secondary storage tank including a secondary inlet, a secondary outlet, a pressure inlet, and a pressure outlet;
a first valve in fluid engagement with the secondary inlet and the primary outlet;
a pressure release valve in fluid communication with the pressure outlet;
a gas pressure supply in fluid engagement with the pressure inlet and in operative engagement therewith to pressurize the secondary storage tank; and
a second valve in fluid engagement with the secondary outlet;
opening the pressure release valve to bring the secondary storage tank to atmospheric pressure;
opening the first valve supplying fluid from the primary storage tank to the secondary storage tank; and
filling the secondary storage tank with a predetermined quantity of fluid, so as the movement of fluid from the primary outlet to the secondary inlet and into the secondary storage tank creates fluid turbulence at the secondary storage tank bottom.

10. (canceled)

11. (canceled)
